(19) United States
(12) Patent Application Publication
(10) Pub. No.: US 2006/0120309 A1
(43) Pub. Date: Jun. 8, 2006

(54) Method, system and apparatus for remote initiation of communications

(75) Inventors: Guy Joseph-Paul Bigras, Rockland (CA); Geoff Dane, Orleans (CA)

Correspondence Address: FETHERSTONHAUGH - SMART & BIGGAR, 1000 DE LA GAUCHETIERE WEST, SUITE 3300, MONTREAL, QC, H3B 4W5, CA

(73) Assignee: BCE Inc., Montreal (CA)

(21) Appl. No.: 11/002,150

(22) Filed: Dec. 3, 2004

(51) Int. Cl. H04B 7/00

(52) U.S. Cl. 370/310

(57) ABSTRACT

The present invention is a method, system and apparatus for remote initiation of communications. In some embodiments, an initiation apparatus establishes communications with a remote device via an intermediate apparatus. The initiation apparatus is coupled to the intermediate apparatus via a packet-based network and the intermediate apparatus is coupled to the remote device via a second network. The initiation apparatus lacks direct access to the second network. The initiation apparatus verifies the integrity of the communication link with the intermediate apparatus. If the integrity of the communications link is confirmed, the initiating apparatus generates a connection initiation request that comprises information representing changed state of at least one control lead. The connection initiation request is relayed to the intermediate apparatus via the packet-based network. The intermediate apparatus extracts information representing the changed state of at least one control leads. Based on the received information, the intermediate apparatus establishes a communication session with the remote device. Upon successful establishment of the communication session, the intermediate device transmits a call set-up confirmation comprising information representing the changed state of at least one control lead to the initiation apparatus. Upon receipt of the call set-up confirmation, a two-way end-to-end communication session is established between the initiation apparatus and the remote device. The present invention further provides an apparatus that allows for generating and relaying various requests via a packet-based network while preserving the information representing the changed state of at least one control lead.

### FIELD OF THE INVENTION

This invention relates generally to network communications, and more specifically to method, system and apparatus for remote initiation of communications.

### BACKGROUND OF THE INVENTION

Modems were developed to send digital data over a phone line. The sending modem modulates the data into a signal that can be transferred in an analog form over a telephone line, and the receiving modem demodulates the signal back into digital data.

Modems were primarily used to enable terminals to connect to computers over the phone lines. With transfers of larger programs and images, modems have constantly been developed to accommodate higher bit-per-second rates required for transfer of larger files. An analog dial up modem requires a phone line to connect to another dial-up modem and establish a handshake. If the handshake procedure is successful, the two modems will establish a communication channel that can be used for transmitting data.

With further developments in the modem art, faster modems have been introduced. For instance, digital subscriber line (DSL) modems utilize specific frequencies on the copper telephone wire that are dedicated for data communications. This allows DSL modems to provide much higher bandwidth communications without disturbing the traditional voice communications. Other high speed modems have also been developed, such as cable modems that utilize a dedicated cable connection. Clearly, DSL and cable modems offer numerous benefits over dial-up modems which are triggering a large number of households and business to switch.

However, there are still computers and other devices equipped with dial-up modems. For example, Automated Teller Machines (ATMs) and Point of Sales (POS) devices have traditionally been equipped with dial-up modems for dialling into a financial transaction processing facility (such as a credit card and/or a bank authorization centre) pool of modems and authorizing a financial transaction. In most locations, ATMs and POS terminals have access to the Public Switched Telephone Network (PSTN) for dialing out and authorizing the transaction. However, if the ATM is located on a moving vehicle, such as a cruise ship, with no direct connection to the PSTN, it is difficult and expensive to dial out to authorize a financial transaction. One possible alternative would be using a satellite phone that is available on some ships. However, communication through satellite phones is expensive, resulting in additional unnecessary costs for ATM providers. Further, audio distortion and jitter (i.e. a rapid variation in latency) present in satellite phone systems could prevent the modems from synchronizing properly. There is a need for a solution for connecting an ATM located onboard of a ship to credit card and/or bank authorization centres in an inexpensive and effective manner.

Further, there is additional equipment that still utilize dial-up modems installed as the only means for establishing communication with a remote device (for example, some video set-top boxes, modems connecting to the back-end of a system or network such as a telephone network, etc). With the push towards communications to be carried over Internet Protocol (IP) or other packet-based networks, these legacy modems may be left behind with no PSTN to communicate across. There is a need for solutions that allow data communications with dial-up modems even when the PSTN may not be easily accessible.

### SUMMARY OF INVENTION

The invention addresses the above stated needs and mitigates at least one of the stated problems by providing a novel method, system and apparatus for remote initiation of communications.

According to one broad aspect of the present invention there is provided an apparatus for initiating communications with a remote device comprising a first interface adapted to be coupled to a packet-based network and a second interface adapted to be coupled to a second network. The apparatus for initiating communication with a remote device further comprises a processing apparatus, coupled to said first and second interfaces, operable to receive a connection initiation request comprising control information via said first interface and to initiate communication with the remote device using said control information through said second interface. The apparatus can further be operable to receive communication data via said first interface and to transmit said communication data to the remote device via said second interface.

According to the second aspect of the present invention there is provided a method of initiating communication with a remote device, comprising receiving a connection initiation request comprising control information via a packet-based network; extracting said control information from said connection initiation request; and initiating communication with the remote device using said extracted control information via a second network;

The method for remote communication initiation further comprises receiving communication data and transmitting said communication data to the remote device via said second network.

According to a third aspect of the present invention, there is provided a system for initiating communication with a remote device comprising:
an initiation apparatus, coupled to a packet-based network, for generating a connection initiation request comprising control information; said initiation apparatus operable to packetize and transmit said connection initiation request over said packet-based network; and
an intermediate apparatus, coupled to said packet-based network and to a second network, for receiving said packetized connection initiation request from said packet-based network; said intermediate apparatus further operable to depacketize said packetized connection initiation request to extract said control information and to initiate communication with the remote device via the second network based on said control information.

According to a fourth aspect of the present invention, there is provided an apparatus for initiation communication with a remote device comprising means for receiving a connection initiation request comprising control information from a packet-based network; means for extracting said control information from said connection initiation request; and means for initiating communication with the remote device using said control information via a second network. The apparatus can further comprise means for receiving communication data and means for transmitting said communication data to the remote device via said second network.

According to a fifth aspect of the present invention, there is provided a computer-readable media storing a plurality of programming instructions for execution on a computing apparatus that is connectable to a packet-based network and to a second network, said instructions for rendering said computing apparatus to receive a connection initiation request comprising control information via said packet-based network; to extract said control information from said connection initiation request; and to initiate communication with a remote device using said control information through said second network; said instructions for further rendering said computing apparatus to receive communication data and to transmit said communication data to the remote device via the second network.

These and other aspects and features of the present invention will now become apparent to those skilled in the art upon review of the following description of specific embodiments of the invention in conjunction with the accompanying drawings.

### BRIEF DESCRIPTION OF THE DRAWINGS

Embodiments of the present invention are described with reference to the following figures, in which:

FIG. 1 is a block diagram illustrating a communication system according to one embodiment of the present invention;

FIG. 2 is a block diagram illustrating the communication system according to another embodiment of the present invention;

FIGS. 3A and 3B are flow charts illustrating the flow of messages within the communication system depicted on FIG. 2;

FIGS. 4A and 4B are block diagrams illustrating communication systems according to two further embodiments of the present invention;

FIG. 5 is a diagram illustrating a standard DB9 connector.

### DETAILED DESCRIPTION OF THE INVENTION

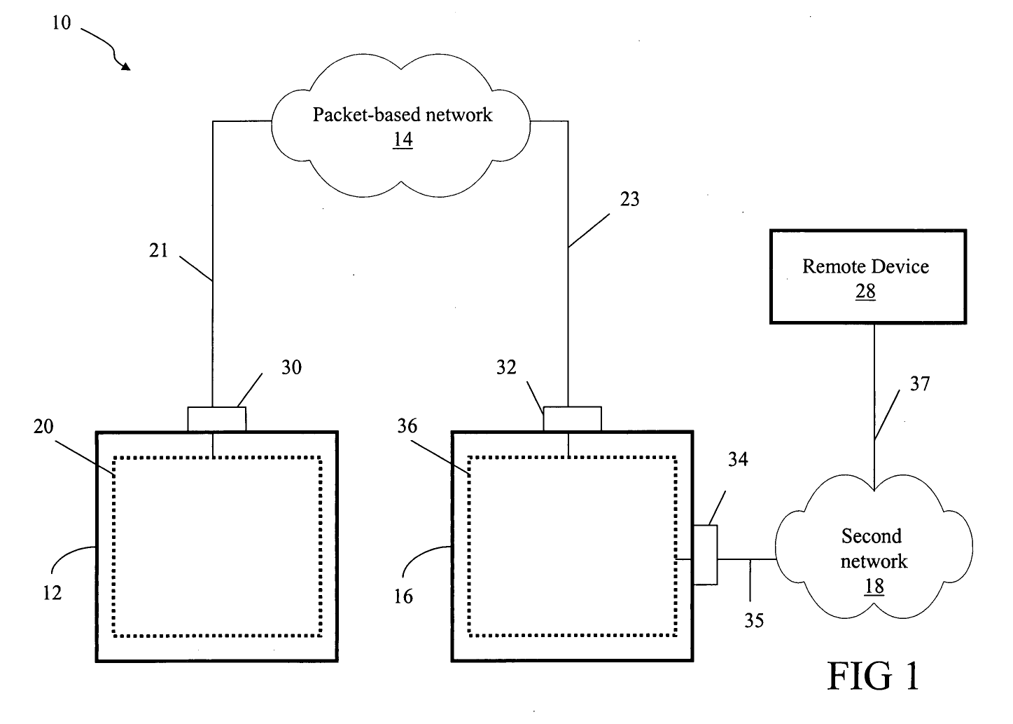

FIG. 1 depicts a block diagram of a communication initiation system 10 according to an embodiment of the present invention. The communication system 10 comprises an initiation apparatus 12 coupled to a packet-based network 14 via an interface 30 that in turn is coupled to a communication link 21. The initiation apparatus 12 comprises a computing apparatus 20 coupled to the interface 30. The interface 30 may comprise an Ethernet jack, a cable jack or the like. It should be understood that the type and configuration of the interface 30 depends on the communication standard used by the packet-based network 14. Generally speaking, the interface 30 may comprise any device that would enable the computing apparatus 20 to connect to the communication link 21.

The type of the packet-based network 14 is not particularly limited. In some embodiments, the packet-based network 14 comprises any IP based network, such as an Internet, an Intranet, a WAN or a LAN. Other alternatives will be apparent to those skilled in the art. The communication link 21 between the initiation apparatus 12 and the packet-based network 14 can comprise any type of access link/connection. A person skilled in the art will appreciate that communication link 21 can comprise a number of routers, repeater hubs and the like required to route packet(s) to/from the packet-based network 14.

The communication system 10 further comprises an intermediate apparatus 16 coupled to the packet-based network 14 via a communication link 23 and to a second network 18 via a communication link 35. The intermediate apparatus 16 comprises a first interface 32 adapted to be coupled to the communication link 23, a second interface 34 adapted to be coupled to the communication link 35, and a processing apparatus 36 coupled to the first and the second interfaces (32, 34). The first interface 32 can be an Ethernet jack, a cable jack or the like. It should be understood that the type and configuration of the first interface 32 depends on the communication standard used by the packet-based network 14. The second interface 34 can comprise an RJ11 phone cable jack, a direct cable connector jack or the like. Further, the second interface 34 can comprise any device that would allow the processing apparatus 36 to connect to the second network 18, this being dependent on the communication standard used by the second network 18.

The second network 18 is coupled to one or more remote devices via respective communication links, only one of each, a remote device 28 and a communication link 37, are shown for simplicity. The type of the remote device 28 is not particularly limited and can comprise any number of computers, modems or other devices compatible with the communication standard used by the second network 18. It should be understood that the term “remote” is not particularly limiting and the remote device 28 can be located in a different country, a different town, a different building, a different room or in a different part of the room with respect to the initiation apparatus 12. For greater clarity, it should be understood that the remote device 28 can either be in the same physical location as the intermediate apparatus 16 (such as the same room) or in a separate location, such as a different room, different building, different city or a different country. Specific examples will be described herein below for a number of possible remote devices 28.

Similarly to the communication link 21, the communication link 23 between the intermediate apparatus 16 and the packet-based network 14 can comprise any type of access link/connection. A person skilled in the art will appreciate that communication link 23 can comprise a number of routers, repeater hubs and the like required to route packet(s) to/from the packet-based network 14.

The type of the second network 18 is not particularly limited and can be a switched network, such as a circuit-switched network (ex. Public Switched Telephone Network) or another switched network (ex. packet-switched network). The second network 18 could also comprise a WiFi network, a Local Area Network (LAN), a Wide Area Network (WAN), an Internet or the like. In other embodiments, the second network 18 can comprise a direct connection between the intermediate apparatus 16 and the remote device 28, such as a cable connection. In yet other embodiments, the second network 18 can comprise a packet-based network that uses communication protocols different from those of the packet-based network 14; a packet-based network with security settings and/or access privileges different from those of the packet-based network 14; and/or a packet-based network that is physically distinct from the packet-based network 14.

Yet in other embodiments, the second network 18 can be based on other communication standards, such as Lon Works promulgated by Echelon Corporation of 550 Meridian Avenue, San Jose, Calif. 95126, USA widely used for networking systems in homes, trains, semiconductor fabrication equipment, intelligent buildings, gas stations and freight train braking systems. Another alternative standard is CE Bus promulgated by CE Bus Industry Council.

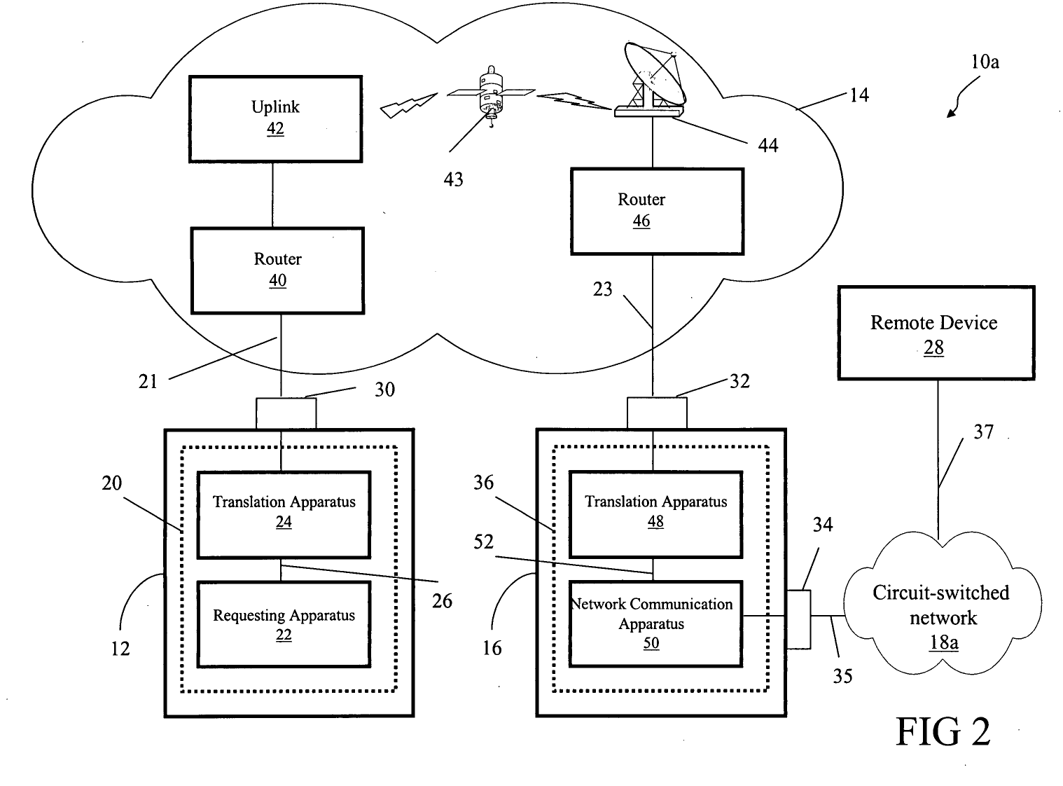

FIG. 2 depicts a block diagram of a communication system 10a according to one embodiment of the present invention. Several components of the communication system 10a are similar to ones of the communication system 10 and are referenced by the same numerals.

In this embodiment of the present invention, the initiation apparatus 12 can be a financial transaction device (for example, an ATM machine, a POS terminal or the like), such as a device installed onboard a cruise ship or a device temporarily installed at events, such as fairs and exhibitions. The initiation apparatus 12 lacks direct access to the second network 18. In one specific non-limiting example, the second network 18 comprises a circuit-switched network 18a, such as a Public Switched Telephone Network (PSTN) or the like.

Whenever a customer wishes to use the financial transaction device to perform a financial transaction (for example, withdraw cash from her debit or credit card using the ATM, pay for purchases using the POS terminal, obtain an account balance using the ATM, transfer funds between accounts using the ATM or the like) the financial transaction device needs to obtain authorization from a financial transaction processing facility (such as a credit card processing facility and/or a bank). The financial transaction processing facilities have a pool of modems that enables financial transaction devices to call in and connect to the authorization server in order to have the financial transactions authorized. Therefore in this embodiment, the remote device 28 is a modem located in the financial transaction processing facility (ex. a credit card processing centre, a bank or the like).

As depicted in FIG. 2, computing apparatus 20 comprises a requesting apparatus 22 and a translation apparatus 24. The requesting apparatus 22 is coupled to the translation apparatus 24 via a communication link 26, such as the well known RS232 standard (developed by the Electronic Industries Associations and which prescribes signal voltages, signal timing, signal function, protocol for information exchange and mechanical connectors). It should be apparent that communication link 26 can comprise other types of links, such as other RSxxx standards, other serial standards, Ethernet, LAN, WiFi or the like. In one non-limiting example, the requesting apparatus 22 can be connected to the communication link 26 using a DE-9 (9 pin) connector. DE-9 connectors are well known to those skilled in the art and sometimes are referred to as DB9 connectors. The terms DE-9 and DB9 are used interchangeably throughout the description herein below. In the same manner, the translation apparatus 24 can be connected to the communication link 26 using a DB9 (9 pin) connector. In other embodiments, a DB25 connector can be used to connect the requesting apparatus 22 and the translation apparatus 24 to the communication link 26. It should be apparent to those skilled in the art, that other connectors compatible with the communications standards and protocols used by the communication link 26 can be used.

The translation apparatus 24 is further coupled to the interface 30 that enables the translation apparatus 24 to connect to the packet-based network 14 via the communication link 21. In some embodiments, the requesting apparatus 22 and the translation apparatus 24 can be embodied into a single device. In other embodiments, the translation apparatus 24 may be outside of the computing apparatus 20 and/or the initiation apparatus 12 and may be connected to the requesting apparatus 22 in a “plug and play” mode. It should be understood that the requesting apparatus 22 or the translation apparatus 24 could comprise a plurality of physical devices or a single device and could be implemented in hardware, firmware, software or any combination thereof.

The translation apparatus 24 can be an RS232 to IP packet(s) converter, such as a Cometh® range device provided by ACKSYS® of 3 & 5 rue du Stade, BP 4580, 78302 Poissy Cedex, France. It should be clear to a person skilled in the art that other translation devices can be used without departing from the teachings of the present invention. The process of generating and transmitting the verification request will be described in further details herein below.

In one specific non-limiting example, the initiation apparatus 12 can be a financial transaction device and the requesting apparatus 22 can comprise a financial transaction device processor. For illustration purposes only, the financial transaction could comprise a person attempting to withdraw cash from her credit card account using the ATM. The customer inserts her credit card into the ATM slot and uses the ATM interface to enter her withdrawal request in a well-known manner. Effectively, the customer enters the financial transaction request.

The requesting apparatus 22 generates a verification request in order to verify the connection between the requesting apparatus 22 and the intermediate apparatus 16 and to confirm that the intermediate apparatus 16 is ready to establish communication with the remote device 28. As will be discussed in greater detail herein below, the generating of the verification request can be in response to the customer entering the financial transaction request, but can also be performed at pre-determined or random time intervals. The requesting apparatus 22 transmits the verification request to the translation apparatus 24 via the communication link 26.

The translation apparatus 24 encodes the verification request according to a specific communication standard/protocol compatible with the packet-based network 14 to create one or more packets that can be transmitted over the packet-based network 14. The type of the encoding protocol is not particularly limiting and may include UDP, TCP or another communication protocol. These communication protocols allow for preservation of the state of control leads information, as will be described in greater detail herein below in connection with control events. The changes performed to the state of the control leads will be described in greater detail herein below. The translation apparatus 24 subsequently transmits the packet(s) comprising the verification request to the intermediate apparatus 26 via the packet-based network 14. For greater certainty, it should be understood that depending on the communication standard used by the packet-based network 14 and the size of the connection initiation request, the translation apparatus 24 can packetize the connection initiation request into a single packet or any number of packets.

As further depicted in FIG. 2, the packet-based network 14 comprises a router 40, an uplink 42, a satellite 43, a teleport infrastructure 44 and a router 46. The translation apparatus 24 transmits the packet(s) to the router 40, such as a Cisco 2621XM router distributed by Cisco Systems Inc. of 170 West Tasman Dr., San Jose, Calif. 95134 USA, via the communication link 21. The router 40 then transmits the packets to the uplink facility 42 that in one embodiment comprises a modem (not depicted for simplicity) such as an iDirect NetModem II provided by www.idirect.net, provided by USA iDirect Technologies of 13865 Sunrise Valey Drive, Hendron, Va. 20171 USA, for receiving the verification request; and a marine stabilized antenna (not depicted for simplicity), such as SeaTel 4996 Marine Stabilized Antenna distributed by SeaTel of 4030 Nelson Avenue Concord, Calif. 94520 USA for uploading the verification request to the satellite 43.

The uplink facility 42 transmits the verification request to the satellite 43, such as the Anik F2 satellite constructed by Boeing Aerospace of 100 North Riverside, Chicago, Ill., 60606 USA and managed by Telesat Canada of 1601 Telesat Court, Gloucester, Ontario K1B 5P4 Canada, which broadcasts the verification request to the teleport infrastructure 44. In one particular non-limiting example, the teleport infrastructure 44 comprises a satellite receiver (not depicted for simplicity) for receiving the broadcasted signal from the satellite 43, such as iDirect ULC Hub and a modem (not depicted for simplicity) such as an iDirect NetModem II for transmitting the verification request to the router 46. The teleport infrastructure 44 transmits the verification request to the router 46, such as a Cisco 2621XM router. It should be clear to a person skilled in the art that other routers may be utilized without departing from the teachings of this invention. The router 46 transmits the verification request to the intermediate apparatus 16 via the communication link 23. One skilled in the art will appreciate that other means to transmit the verification request between the teleport facility 44 and the intermediate apparatus 16 are possible, for example, a direct link.

With further reference to FIG. 2, the processing apparatus 36 of the intermediate apparatus 16 comprises a translation apparatus 48 coupled to the first interface 32 and a network communication apparatus 50 coupled to the second interface 34. The translation apparatus 48 may be similar to the translation apparatus 24 and, in one specific non-limiting example, can be an RS232 to IP packet converter, such as a Cometh® range device. The network communication apparatus 50 can be a modem, such as a generic analog 33.6 Kbps modem manufactured and distributed by Boca Research of 1601 Clint Moore Road, Suite 200, Boca Raton, Fla. 33487 USA. It should be understood that other translation devices and other types of network communication apparatus can be used without departing from the teachings of the present invention.

The translation apparatus 48 is coupled to the network communication apparatus 50 via a communication link 52. The communication link 52 can be based on the well known RS232 standard. It should be clear to a person skilled in the art that the communication link 52 could comprise other types of links, such as other RSxxx standards, other serial standards, Ethernet, LAN, WiFi or the like. It should be understood that the network communication apparatus 50 or the translation apparatus 48 could comprise a plurality of physical devices or a single device and could be implemented in hardware, firmware, software or any combination thereof.

The translation apparatus 48 receives the packet(s) comprising the verification request from the packet-based network 14 via the communication link 23 and de-packetizes the packets to extract the verification request. The translation apparatus 48 then relays the verification request to the network communication apparatus 50 via the communication link 52. The network communication apparatus 50 verifies that it is ready to initiate communications via a circuit-switched network 18a. This verification procedure is inherent in the network communication apparatus 50 and will be apparent to those skilled in the art. If the network communication apparatus 50 is ready to establish the communication, it confirms its readiness to the initiation apparatus 12 by transmitting a confirmation signal to the initiation apparatus 12 via the packet-based network 14. For greater certainty, it should be apparent to a person skilled in the art, that both the uplink facility 42 and the teleport facility 44 are operable to transmit data in both directions—to and from the satellite 43.

In some embodiments of this invention, as will be described in greater detail herein below, the process of checking the connection between the requesting apparatus 22 and the network communication apparatus 50 and whether the network communication apparatus 50 is ready to establish communications is performed periodically irrespective of whether or not the financial transaction request has been received at the requesting apparatus 22. For greater certainty, “periodically” can be either at a pre-determined time interval (such as 5 minutes, 30 minutes, 1 hours, 2 hours or the like) or randomly. In other embodiments of the present invention, the process of checking is performed “on-demand” (for example, after a financial transaction request has been received).

Upon receipt of the packet(s) comprising the confirmation signal via the interface 30, the translation apparatus 24 processes the packet(s) to extract the confirmation signal and relay the confirmation signal to the requesting apparatus 22. At this stage, the network communication apparatus 50 has effectively confirmed the integrity of the connection between the requesting apparatus 22 and the network communication apparatus 50 and the readiness to establish communications upon request.

In operation of system 10a, the requesting apparatus 22 generates a connection initiation request. In case that the requesting apparatus 22 is configured to perform the verification procedure described above in an “on-demand“ mode, the verification procedure has to be run and completed before the connection initiation request is generated. In some embodiments, the connection initiation request comprises control information. The control information can comprise a triggering signal which can comprise information representing a changed state of at least one control lead as will be described in greater detail herein below. The control information can further comprise an identifier associated with the remote device 28, which in this embodiment comprises a phone number associated with the financial transaction processing facility that can be used to call the modem located at the financial transaction processing facility via the circuit-switched network 18a. The control information can be used by the network communication apparatus 50 to establish communication with the remote device 28.

In other embodiments, the remote device identifier is transmitted separately from the control information and the connection initiation request is meant to alert the network communication apparatus 50 that the requesting apparatus 22 needs to establish communications with the remote device 28 and that the remote device identifier will follow suit. In other embodiments, the remote device identifier is pre-programmed into the network communication apparatus 50 or is obtainable by the network communication apparatus 50 from an external source (such as within database accessible by the processing apparatus 36). In these embodiments, the network communication apparatus 50 uses the communication initiation request to trigger the process of obtaining the remote device identifier if it is stored at an external source. Further, the network communication apparatus 50 uses the communication initiation request to establish communication with the remote device 28.

The requesting apparatus 22 relays the connection initiation request to the translation apparatus 24 via the communication link 26. The translation apparatus 24 receives the connection initiation request, packetizes the connection initiation request into one or more packets compatible with the packet-based network 14 and transmits the packet(s) to the intermediate apparatus 16 via the packet-based network 14. Depending on the communication standard used by the packet-based network 14 and the size of the connection initiation request, the translation apparatus 24 can packetize the connection initiation request into a single packet or any number of packets.

The translation apparatus 48 receives the packet(s) comprising the connection initiation request from the packet-based network 14 via the communication link 23. The translation apparatus 48 de-packetizes the packet(s), extracts the connection initiation request from the packet(s) and relays the connection initiation request to the network communication apparatus 50. As described above, in one embodiment, the connection initiation request is relayed to the network communication apparatus 50 using the well known RS232 standard.

The network communication apparatus 50 receives the connection initiation request from the translation apparatus 48, extracts the remote device identifier and dials out to the remote device 28 via the circuit-switched network 18a using the remote device identifier. The remote device 28 answers the call in a manner well-known in the art. The network communication apparatus 50 and the remote device 28 exchange call set-up information during a procedure commonly known as the “handshake”. Upon the successful completion of the “handshake”, the network communication apparatus 50 and the remote device 28 establish a two-way communication channel via the circuit-switched network 18a.

Once the two-way communication channel between the network communication apparatus 50 and the remote device 28 is established, the network communication apparatus 50 transmits a call set-up confirmation signal to the translation apparatus 48. The translation apparatus 48 packetizes the call set-up confirmation signal into one or more packets compatible with the packet-based network 14 and transmits the packet(s) to the translation apparatus 24 via the packet-based network 14. The translation apparatus 24 receives the packet(s) comprising the call set-up confirmation signal from the packet-based network 14, de-packetizes the packet(s) to extract the call set-up confirmation signal and relays the call set-up confirmation signal to the requesting apparatus 22 via the communication link 26. Upon receipt of the call set-up confirmation signal by the requesting apparatus 22, an end-to-end two-way communication session is established between the initiation apparatus 12 and the remote device 28 via the packet-based network 14, the intermediate apparatus 16 and the circuit-switched network 18a. Effectively, the financial transaction device (an ATM, a POS or the like) is enabled to initiate communication with the remote device 28 in the financial transaction processing facility via the network communication apparatus 50.

Upon the establishment of the two-way communication session, the requesting apparatus 22 generates communication data and transmits the communication data to the remote device 28 using the two-way communication session. The communication data can comprise a financial transaction request either for a credit card or a debit card transaction authorization. In case of the credit card, such a financial transaction request can comprise credit card number, credit card expiry date and the customer entered Personal Identification Number (PIN) if the financial transaction request is for withdrawal of cash, as well as the dollar amount that requires authorization. In case of the debit card, such a financial transaction request comprises a bank card and/or account identifier, the customer entered PIN and the purchase amount that requires authorization. It should be apparent to a person skilled in the art, that any combination of identifiers, PINs, security questions and the like may form part of the financial transaction request and this depends on the financial institution. Upon receipt of the communication data, the remote modem 28 is operable to process the communication data. In one example, the remote modem 28 extracts the financial transaction request from the communication data by de-modulation in a manner well known in the art and authorizes the credit/debit card transaction. The credit/debit card authorization process will be apparent to those skilled in the art and may comprise any number of steps, such as comparing the PIN associated with the credit/debit card number with the customer entered PIN, comparing the credit/debit card number with the list of stolen credit/debit cards numbers, checking the availability of funds and the like. It should be noted, that for simplicity, the elements required for the financial transaction request processing are not shown.

The remote device 28 sends the communication data back to the network communication apparatus 50 via the circuit-switched network 18a, which is then operable to relay the communication data to the initiation apparatus 12 via the packet-based network 14. In one non-limiting example, the communication data relayed by the remote device 28 comprises the financial transaction authorization. It should now be apparent that upon receipt of the communication data comprising a successful financial transaction authorization, the requesting apparatus 22 can proceed and fulfill the financial transaction request, whether it is to dispense cash or accept payment for a purchase through the POS terminal.

In some embodiments of the present invention, the initiation apparatus 12 transmits the connection initiation request and the communication data to the remote device 28 simultaneously. In other embodiments, the communication data incorporates the connection initiation request. In yet other embodiments, the connection initiation request incorporates the communication data.

In some embodiments of the present invention, the initiation apparatus 12 can establish a secure connection with the intermediate apparatus 16 (for example: a VPN connection or an IP Sec tunnel). In these embodiments, the data contained in payloads of the IP packets transmitted between the initiation apparatus 12 and the remote device 28 is encrypted using well known encryption protocols used in the financial or other industries (such as 3DES, AES and the like). In some embodiments, to further improve the level of security and preserve the integrity of the exchanged data, an IP Sec tunnel is established between router 40 and router 46 by techniques well known in the art.

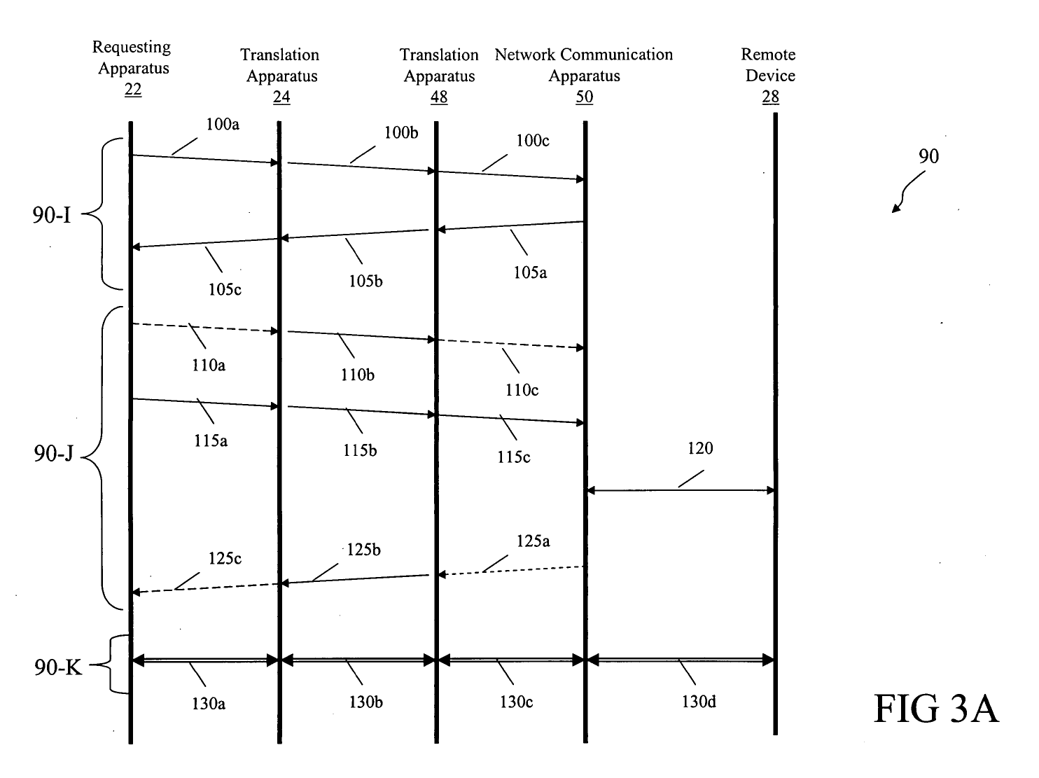

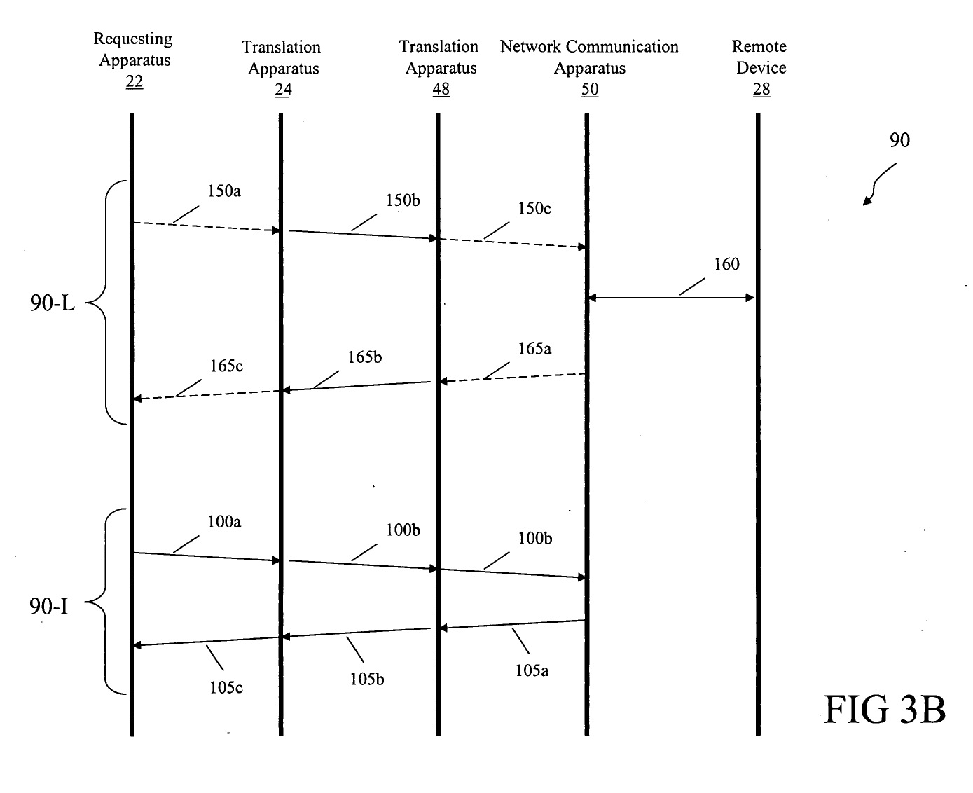

A method of remote communication initiation according to one embodiment of the present invention will now be described in greater detail with reference to a signal flow chart of FIG. 3A. In order to assist in the explanation of the method, it will be assumed that method 90 is operated using the system 10a of FIG. 2. Furthermore, the following discussion of method 90 will lead to further understanding of system 10a and its various components. It should be understood that steps in method 90 need not be performed in the sequence shown. Further, it is to be understood that system 10a and/or method 90 can be varied, and need not work as discussed herein in conjunction with each other, and that such variations are within the scope of the present invention.

For clarity within FIGS. 3A and 3B, message streams have been depicted as solid single lines, control events have been depicted as single dotted lines and communication sessions have been depicted as double solid lines.

At step 90-I, the initiation apparatus 12 verifies the connection between the requesting apparatus 22 and the network communication apparatus 50. Step 90-I can be performed in response to a customer entering a financial transaction request at the initiation apparatus 12 (such as a cash withdrawal request from a credit/debit card using an ATM or a request to pay for purchases using a debit card via a POS terminal). Alternatively, step 90-I can be performed periodically. In one specific non-limiting example, step 90-I is performed every 60 seconds. In other embodiments, step 90-I is performed at random intervals. It should be apparent; that step 90-I can be performed at any pre-determined or random interval, this being dependent on the type and components of packet-based network 14 which forms part of the system 10a, as well as costs and latency associated with using the packet-based network 14.

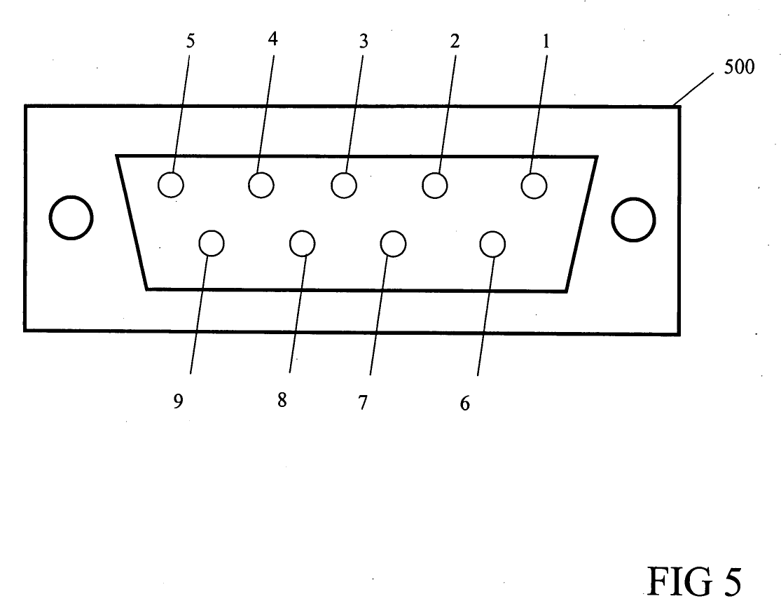

In order to describe the process of generating and transmitting various requests according to the method 90, it should be recalled that in one embodiment, the requesting apparatus 22 can be coupled to the communication link 26 by means of the DB9 connector. In the same manner, the translation apparatus 24 can be coupled to the communication link 26 by means of the DB9 connector. A reference will now be made to FIG. 5 that depicts a female DB9 connector. The DB9 connector is generally indicated at 500. The DB9 connector 500 comprises 9 pins 1-9, each pin associated with a different control lead. The association between pins of the DB9 connector and the corresponding control lead is commonly referred to as “pinout”. The pinouts for DB9 connectors of the requesting apparatus 22 and translation apparatus 24, according to one embodiment of the present invention, will now be explained in greater detail with reference to Table 1:

TABLE 1

| Requesting Apparatus 22 | | | Translation Apparatus 24 | | |
|---|---|---|---|---|---|
| PIN | Description | Direction | PIN | Description | Direction |
| 1 | Data Carrier Detect (DCD) | Input | 8 | Request to Send (RTS) | Output |
| 2 | Receive Data (RD) | Input | 2 | Transmit Data (TD) | Output |
| 3 | Transmit Data (TD) | Output | 3 | Receive data (RD) | Input |
| 4 | Data Terminal Ready (DTR) | Output | 4 | Data Set Ready (DSR) | Input |
| 5 | Ground (SGND) | n/a | 5 | Ground (SGND) | n/a |
| 6 | Data Set Ready (DSR) | Input | 6 | Data Terminal Ready (DTR) | Output |
| 7 | Request to Send (RTS) | Output | 7 | Clear To Send (CTS) | Input |
| 8 | Clear to Send (CTS) | Input | 1 | Data Carrier Detect (DCD) | Input |
| 9 | Ring Indicator (RI) | Output | 9 | Ring Indicator (RI) | Input |

Table 1 depicts the nine pins available on the DB9 connector which are well known to those skilled in the art. The first column contains the pin number, the second column contains the control lead associated with the pin number and the third column contains a direction of signal flow.

It should, however, be noted that the RD (Receive Data) pin is sometimes referred to as the RxD or Rx pin. RD, RxD and Rx terms are used interchangeably herein below. In the same manner, the TD pin is sometimes referred to as TxD or Tx pin. TD, TxD and Tx terms are used interchangeably herein below.

As shown in Table 1, in one specific, non-limiting example, pin 4 of the DB9 connector of the requesting apparatus 22 is associated with the DTR (Data Terminal Ready) control lead and is an “output” pin (i.e. the pin is used to send a signal from the requesting apparatus 22). Pin 4 of the DB9 connector of the translation apparatus 24 is associated with the DSR (Data Set Ready) control lead and is an “input” pin (i.e. the pin is used to receive a signal by the translation apparatus 24). As will be apparent to those skilled in the art, that DB9 connectors associated with both the requesting apparatus 22 and the translation apparatus 24 in this embodiment of the present invention have pinouts generally associated with Data Terminal Equipment (the DTR, TD and RTS pins are output pins; and the RD, DSR and CTS are input pins). It should be understood by a person skilled in the art that different pinouts can be used for carrying out the teachings of this invention.

It should be clear that not all the pins of the DB9 connectors are used for sending and receiving data or control information. In some embodiments of the present invention, pins 6, 7, 8 and 9 of the DB9 connector of the translation apparatus 24 are not used. In other embodiments, certain pins can be interconnected with each other, for example pins 6, 7 and 8 of the DB9 connector of the requesting apparatus 22 can be interconnected.

Each pin can have two states: “active” and “inactive” (commonly referred to as “high” and “low”). The term “changes the state of a control lead” on a particular pin, as used throughout this description herein below, means changing the state of a particular pin associated with a specific control lead from “active” to “inactive” or from “inactive” to “active”. For greater clarity, the following example is provided for illustration purposes only. When the state of the DTR control lead is changed from “inactive” to “active”, voltage is applied to the DTR pin of the DB9 connector, thus rendering the DTR control lead “active”. In the same manner, when changing the status of the DTR control lead from “active” to “inactive”, the applied voltage is discontinued on the DTR pin of the DB9 connector, thus rendering the DTR control lead “inactive”. It should be understood, that “active” and “inactive” states could be opposite from this example.

The requesting apparatus 22 generates a message stream 100a comprising the verification request. In one specific non-limiting example, the verification request comprises a verification of connection between the requesting apparatus 22 and the network communication apparatus 50. This type of queries is generally referred to as AT Queries. For example, an ATH0 command hangs up a call established by the modem. The requesting apparatus 12 transmits the message stream 100a comprising the verification request to the translation apparatus 24 through the TxD pin of its DB9 connector coupled to the communication link 26. The translation apparatus 24 receives the message stream 100a through its RxD pin of the DB9 connector coupled to the communication link 26.

Effectively, the requesting apparatus 22 has transmitted the verification request comprising the ATx Query to the translation apparatus 24.

The translation apparatus 24 generates a message stream 100b by translating the verification request into one or more packets (the process referred to as “packetizing”). It should be apparent that the encoding protocol used for packetizing is dependent on the communication standard and protocols used by the packet-based network 14. The encoding protocol can be UDP, TCP or the like. The translation apparatus 24 transmits the packet(s) comprising the message stream 100b to the translation apparatus 48 via the packet-based network 14. It will be recalled that the packet-based network 14, as depicted in FIG. 2, comprises the router 40, the uplink 42, the satellite 43, the teleport infrastructure 46 and the router 46. Therefore, it should be apparent, that the packet(s) comprising the message stream 100b further comprise information required for routing the packet(s) through the packet-based network 14 to the translation apparatus 28. In one specific non-limiting example, the touting information can be an IP address associated with the translation apparatus 48. Other alternative types of routing information will be apparent to those skilled in the art.

The translation apparatus 48 receives the packet(s) comprising the message stream 100b from the packet-based network 14 via the communication link 23. The translation apparatus 48 processes the received message stream 100b to extract the verification request. In one specific non-limiting example, the translation apparatus 48 de-packetizes the packet(s) comprising the message stream 100b according to a specific encoding protocol used to packetize the message stream 100b by the translation apparatus 24 (for example: UDP, TCP or the like). Effectively, the translation apparatus 48 has received the verification request comprising the ATx Query.

Similar to the translation apparatus 24 and the requesting apparatus 22, the translation apparatus 48 can be connected to the communication link 52 by a DB9 connector and the network communication apparatus 50 can be connected to the communication link 52 using a DB9 connector. The pinouts for DB9 connectors of the translation apparatus 48 and the network communication apparatus 50 according to one embodiment of the present invention will now be explained in greater detail with reference to Table 2:

TABLE 2

| Translation Apparatus 48 | | | Network Communication Apparatus 50 | | |
|---|---|---|---|---|---|
| PIN | Direction | Direction | PIN | Direction | Direction |
| 1 | Data Carrier Detect (DCD) | Input | 6 | Data Set Ready (DSR) | Output |
| 2 | Transmit Data (TD) | Output | 3 | Transmit Data (TD) | Input |
| 3 | Receive Data (RD) | Input | 2 | Receive Data (RD) | Output |
| 4 | Data Set Ready (DSR) | Input | 8 | Clear To Send (CTS) | Output |
| 5 | Ground (SGND) | n/a | 5 | Ground (SGND) | n/a |
| 6 | Data Terminal Ready (DTR) | Output | 4 | Data Terminal Ready (DTR) | Input |
| 7 | Clear To Send (CTS) | Input | 1 | Data Carrier Detect (DCD) | Output |
| 8 | Request To Send (RTS) | Output | 7 | Request to send (RTS) | Input |
| 9 | Ring Indicator (RI) | Input | 9 | Ring Indicator (RI) | Output |

As shown in Table 2, in one specific, non-limiting example, pin 6 of the DB9 connector of the translation apparatus 48 is associated with the DTR (Data Terminal Ready) control lead and is an “output” pin (i.e. the pin is used to send a signal from the translation appratus 48). Pin 4 of the DB9 connector of the network communication apparatus 50 is associated with the DTR (Data Terminal Ready) control lead and is an “input” pin (i.e. the pin is used to receive a signal by the network communication apparatus 50). As will be apparent to those skilled in the art, the translation apparatus 48 in this embodiment of the present invention has pinouts generally associated with Data Terminal Equipment (the DTR, TD and RTS pins are output pins; and the RD, DSR and CTS are input pins). The network communication apparatus 50, on the other hand, in this embodiment of the present invention has pinouts generally associated with Data Communication Equipment, due to the fact that it has a “reverse” pinout from that of Data Terminal Equipment (namely, the Data Communication Equipment pinout is generally understood to be chacterized by the DTR, TD and RTS pins being input pins; and the RD, DSR and CTS being output pins). It should be understood by a person skilled in the art that different pinouts can be used for carrying out the teachings of this invention.

Not all the pins of the DB9 connectors are used for sending and receiving data or control information. In some embodiments of the present invention, pins 1, 4, 8 and 9 of the DB9 connector of the translation apparatus 48 are not used. In other embodiments, certain pins can be interconnected with each other, for example pins 1 and 7 of the DB9 connector of the network communication apparatus 50 can be interconnected.

The translation apparatus 48 then generates a message stream 100c. The translation apparatus 48 transmits the message stream 100c comprising the verification request to the network communication apparatus 50 through the TxD pin of its DB9 connector coupled to the communication link 52. The network communication apparatus 50 receives the message stream 100c through its TxD pin of the DB9 connector coupled to the communication link 52. Effectively, the translation apparatus 48 has transmitted the verification request comprising the ATx Query to the network communication apparatus 50.

At this stage, the network communication apparatus 50 verifies the integrity of the connection between the requesting apparatus 22 and the network communication apparatus 50 itself and further checks if it is ready to establish communications via the circuit-switched network 18 based on the received ATx Query. In one embodiment of the present invention, the fact that the network communication apparatus 50 has received the verification request from the requesting apparatus 22 verifies the integrity of the connection between the requesting apparatus 22 and the network communication apparatus 50. This process of verifying the readiness to establish communications is inherent in the network communication apparatus 50 and will be apparent to those skilled in the art. If the network communication apparatus 50 is ready to establish communicationsvia the circuit-switched network 18a and the integrity of the connection between the requesting apparatus 22 and the network communication apparatus 50 has been confirmed, the network communication apparatus 50 transmits a confirmation signal to the initiation apparatus 12. In one specific non-limiting example, the confirmation signal can comprise an ATx Response.

The network communication apparatus 50 generates a message stream 105a comprising the confirmation signal. The network communication apparatus 50 transmits the message stream 105a to the translation apparatus 48 through the RxD pin of its DB9 connector coupled to the communication link 52. The translation apparatus 48 receives the message stream 105a through the RxD pin of its DB9 connector coupled to the communication link 52. Effectively, the network communication apparatus 50 has transmitted the confirmation signal comprising the ATx Response to the translation apparatus 48.

The translation apparatus 48 then generates a message stream 105b comprising the confirmation signal. The translation apparatus 48 packetizes the message stream 105b into one or more packets compatible with the packet-based network 14 and transmits the packet(s) comprising the message stream 105b to the translation apparatus 24 over the packet-based network 14. The packet(s) comprising the message stream 105b further comprises information required for routing the packet(s) comprising the message stream is 105b through the packet-based network 14 to the translation apparatus 24. In one specific non-limiting example, the routing information comprises an IP address associated with the translation apparatus 24. Other alternative routing information will be apparent to those skilled in the art.

The translation apparatus 24 receives the packet(s) comprising the message stream 105b and extracts the confirmation signal from the message stream 105b. The translation apparatus 24 generates a message stream 105c comprising the confirmation signal and relays the message stream 105c to the requesting apparatus 22 through its TxD pin of the DB9 connector coupled to the communication link 26. The requesting apparatus 22 receives the message stream 105c through the RxD pin of its DB9 connector coupled to the communication link 26.

At this point, the requesting apparatus 22 has effectively received the ATx Response confirming the integrity of the connection between the requesting apparatus 22 and the network communication apparatus 50 and that the network communication apparatus 50 is ready to establish communications via the circuit-switched network 18a. It should be reinforced, that step 90-I can be performed periodically, at random intervals or at pre-determined intervals (for example, every 30 seconds, every 5 minutes, every 30 minutes, every hour, every 4 hours or the like). Alternatively, step 90-I can be performed “on-demand”, that is only after a financial transaction request has been received by the requesting apparatus 22 (for example, a customer has attempted to withdraw cash from the ATM using her credit card). It should be apparent, that the timing of step 90-I depends on many parameters, such as bandwidth, latency and costs associated with transmitting data over the packet-based network 14, type of the requesting apparatus 22, type of the network communication apparatus 50, as well as other elements of the system 10a.

On the other hand, if the integrity of connection between the requesting apparatus 22 and the network communication apparatus 50 is not confirmed at step 90-I, the requesting apparatus is not able to establish communication with the remote device 28. In one specific non-limiting example, the ATM will display an error message, such as “The service you have requested is not available due to technical reasons. We apologize for any inconveniences caused”. In some embodiments of the present invention, the requesting apparatus 22 can re-run step 90-I after a pre-determined period of time to re-check for the integrity of the connection. In other embodiments, a service ticket is generated by the ATM.

For further discussion, it will be assumed that step 90-I has been completed and the method 90 proceeds to step 90-J, wherein the initiation apparatus 12 initiates communications with the remote device 28 via the packet-based network 14, the intermediate apparatus 16 and the circuit-switched network 18a. The requesting apparatus 22 monitors if a financial transaction request has been received. For illustration purposes only, it will be assumed that the financial transaction request comprises a request for a cash withdrawal from a credit card account and this request has been received by the requesting apparatus 22.

The requesting apparatus 22 creates a first stage of a connection initiation request by generating a control event 110a. In one specific non-limiting example, the control event 110a is a change of state of the DTR control lead of the DB9 connector of the requesting apparatus 22. The translation apparatus 24 receives the control event 110a through a change of state of the DSR control lead of its DB9 connector from “inactive” to “active”. Effectively, the requesting apparatus 22 has transmitted the control event 110a to the translation apparatus 24.

The translation apparatus 24 generates a message stream 110b by converting the information representing the changed state of the DSR control lead into one or more packets. It should be apparent that the encoding protocol used for packetizing is dependent on the communication standard and protocols used by the packet-based network 14. The translation apparatus 24 transmits the packet(s) comprising the message stream 110b to the translation apparatus 48 via the packet-based network 14. The packet(s) comprising the message stream 110b further comprise information required for routing the packet(s) through the packet-based network 14 to the translation apparatus 28. In one specific non-limiting example, the routing information comprises an IP address associated with the translation apparatus 48. Other alternative routing information will be apparent to those skilled in the art.

The translation apparatus 48 receives the packet(s) comprising the message stream 110b from the packet-based network 14 via the communication link 23. The translation apparatus 48 processes the received packet(s) comprising the message stream 110b to extract the information representing the changed state of the DSR control lead. In one specific non-limiting example, the translation apparatus 48 de-packetizes the control event 150b according to a specific encoding protocol used (for example: UDP, TCP or the like).

Based on the received information representing the changed state of the DSR control lead, the translation apparatus 48 generates a control event 110c. In one specific non-limiting example, the control event 110c is a change of state of the DTR control lead of the DB9 connector of the translation apparatus 48 from “inactive” to “active”. The network communication apparatus 50 receives the control event 110c through a change of state of the DTR control lead of its DB9 connector from “inactive” to “active”. Effectively, the translation apparatus 48 has transmitted the first stage of the connection initiation request to the network communication apparatus 50. At this stage, the network communication apparatus 50 is ready to dial out to the remote device 28 via the circuit-switched network 18a.

As depicted in FIG. 3A, the requesting apparatus 22 creates a second stage of the connection initiation request by generating a message stream 115a comprising the remote device identifier. In one specific non-limiting example, the remote device identifier can be the phone number associated with the remote device 28. It should be apparent, that other types of remote device identifiers can be used, such as other unique network identifiers, IP addresses or the like, this being dependent on the communication standard used by the second network 18. The requesting apparatus 12 transmits the message stream 115a comprising the remote device identifier to the translation apparatus 24 via the TxD pin of the DB9 connector coupled to the communication link 26. The translation apparatus 24 receives the message stream 115a comprising the remote device identifier via the TxD pin of the DB9 connector coupled to the communication link 26.

The translation apparatus 24 generates a message stream 115b by converting the remote device identifier into one or more packets compatible with the packet-based network 14. It should be apparent that the encoding protocol used for packetizing is dependent on the communication standard and protocols used by the packet-based network 14. The translation apparatus 24 transmits the packet(s) comprising the message stream 115b to the translation apparatus 48 via the packet-based network 14. The packet(s) comprising the message stream 115b further comprise information required for routing the packet(s) through the packet-based network 14 to the translation apparatus 28. In one specific non-limiting example, the routing information comprises an IP address associated with the translation apparatus 48. Other alternative routing information will be apparent to those skilled in the art.

The translation apparatus 48 receives the packet(s) comprising the message stream 115b from the packet-based network 14 via the communication link 23. The translation apparatus 48 processes the received packet(s) comprising the message stream 115b to extract the remote device identifier. In one specific non-limiting example, the translation apparatus 48 de-packetizes the message stream 115b according to a specific encoding protocol used (for example: UDP, TCP or the like).

The translation apparatus 48 then generates a message stream 115c comprising the remote device identifier and transmits the message stream 115c to the network communication apparatus 50 via the TxD pin of its DB9 connector coupled to the communication link 52. The network communication apparatus 50 receives the message stream 115c via the TxD pin of its DB9 connector coupled to the communication link 52 and extracts the remote device identifier. It should be understood that in this non-limiting embodiment, the received control event 110c and received message stream 115c in combination comprise a connection initiation request. In other embodiments, other connection initiation requests could be utilized. For instance, both stages of the connection initiation request could be combined into a single message stream; or only one of a control event and a message stream could be transmitted as a connection initiation request.

In response to the connection initiation request, the network communication apparatus 50 dials out to the remote device 28 via the circuit-switched network 18 using the received remote device identifier. The process of dialling out is inherent to the network communication apparatus 50 and will be clear to those skilled in the art. The remote device 28, which in this embodiment is a modem, answers the call from the network communication apparatus 50 via the circuit-switched network 18a and a “handshake” is established by exchange of message stream 120 between the modems.

Upon a successful handshake, the network communication apparatus 50 generates a control event 125a comprising the call set-up confirmation signal. In one specific non-limiting example, the control event 125a is a change of state of the DCD control lead of the DB9 connector of the network communication apparatus 50 from “inactive” to “active”. The translation apparatus 48 receives the control event 125a through a change of state of the CTS control lead of its DB9 connector from “inactive” to “active”. Effectively, the network communication apparatus 50 has transmitted the call set-up confirmation signal to the translation apparatus 48.

The translation apparatus 48 generates a message stream 125b by converting the information representing the changed state of the CTS control lead into one or more packets compatible with the packet-based network 14. The translation apparatus 48 transmits the packet(s) comprising the message stream 125b to the translation apparatus 24 via the packet-based network 14. The packet(s) comprising the message stream 125b further comprise information required for routing the packet(s) through the packet-based network 14 to the translation apparatus 24. In one specific non-limiting example, the routing information comprises an IP address associated with the translation apparatus 24. Other alternative routing information will be apparent to those skilled in the art.

The translation apparatus 24 receives the packet(s) comprising the message stream 125b from the packet-based network 14 and extracts the information representing the state of the CTS control lead. Based on the received information representing the changed state of the CTS control lead, the translation apparatus 24 generates a control event 125c comprising the call set-up confirmation signal. In one specific non-limiting example, the control event 125c is a change of state of the RTS control lead of the DB9 connector of the translation apparatus 24 from “inactive” to “active”. The requesting apparatus 22 receives the control event 125c through a change of state of the DCD control lead of its DB9 connector from “inactive” to “active”. Effectively, the translation apparatus 24 has transmitted the call set-up confirmation signal to the requesting apparatus 22.

At this stage, a two-way communication session is established between the requesting apparatus 22 and the remote device 28, depicted as a sum of message streams 130a, 130b, 130c and 130d, jointly referred to as 90-K.

The requesting apparatus 22 then generates communication data for transmission to the remote device 28. It should be understood that at this stage the remote device 28 could further generate the communication data for transmission to the requesting apparatus 22. As was described in greater detail above, the communication data can comprise a request for financial transaction authorization. The requesting apparatus transmits the communication data to the remote device 28 using the two-way session 90-K. The remote device 28 receives the communication data through the session 90-K, processes the communication data in any desired manner and transmits communication data back to the requesting apparatus 22 via the two-way session 90-K. In one example, the communication data sent by the remote device 28 to the requesting apparatus 22 can comprise a financial transaction authorization.

It should be understood that, in some embodiments of the present invention, the message streams 115a, 115b and 115c comprising the remote device identifier can be merged with the message streams 100a, 100b and 100c, that is the control event 100a will be combined with the message stream 115a. In the same manner, the message stream 100b and 115b will be combined, as well as the message streams 100c and 115c. In other embodiments, as briefly discussed above, the connection initiation request could comprise only one of the control event 100c and the message stream 115c. In some embodiments, the remote device identifier could be known to the network communication apparatus 50 and upon receipt of the control event 110c, the modem will initiate the connection procedure with the remote device 28 based on the already communicated or pre-programmed remote device identifier. It should be understood that the control event 110c in this embodiment and in the embodiment described in detail above with reference to FIG. 3A can be considered a triggering signal and other triggering signals could be utilized to initiate the connection procedure. For instance, other control lead event(s) or a triggering message stream could be utilized that the network communication apparatus 50 understands should trigger it to begin the connection procedure with the remote device 28.

A reference is now made to FIG. 3B that depicts a signal flow chart for terminating the two-way session between the requesting apparatus 22 and the remote device 28 according to one embodiment of the present invention. It will be assumed that the two-way session 90-K between the requesting apparatus 22 and the remote device 28 has been established, as described in greater detail in reference to FIG. 3A.

It will be recalled, that during the communication initiation procedure (Step 90-J of FIG. 3A), the state of the DTR and DSR control leads changed from “inactive” to “active”. It should be reinforced, that the state of the DTR and DSR control leads are maintained at the “active” state throughout the communication session (Step 90-K of FIG. 3A).

At step 90-L the initiation apparatus 12 tears down the two-way session with the remote device 28. In one non-limiting example, the requesting apparatus 22 generates a control event 150a comprising a call termination request at step 90-L upon completion of the financial transaction (for example, a customer successfully withdrawing cash using the ATM from her credit card account). In one specific non-limiting example, the control event 150a is a change of state of the DTR control lead of the DB9 connector of the requesting apparatus 22 from “active” to “inactive”. The translation apparatus 24 receives the control event 150a through a change of state of the DSR control lead of its DB9 connector from “active” to “inactive”. Effectively, the requesting apparatus 22 has transmitted the call termination request to the translation apparatus 24.

The translation apparatus 24 generates a message stream 150b by converting the information representing the changed state of the DSR control lead into one or more packets compatible with the packet-based network 14 (the process is similar to the one described in relation to the message stream 110b). The translation apparatus 24 transmits the packet(s) comprising the message stream 150b to the translation apparatus 24 via the packet-based network 14. The packet(s) comprising the message stream 150b further comprise information required for routing the packet(s) through the packet-based network 14 to the translation apparatus 48. In one specific non-limiting example, the routing information comprises an IP address associated with the translation apparatus 48. Other alternative routing information will be apparent to those skilled in the art.

The translation apparatus 48 receives the packet(s) comprising the message stream 150b from the packet-based network 14 via the communication link 32. The translation apparatus 48 processes the received packet(s) comprising the message stream 150b to extract the information representing the changed state of the DSR control lead. As was discussed in greater detail above, the translation apparatus 48 can de-packetize the received packet(s) according to specific protocols.

Based on the received information representing the changed state of the DSR control lead, the translation apparatus 48 generates a control event 150c comprising the call termination request. In one specific non-limiting example, the control event 150c is a a change of state of the DTR control lead of the DB9 connector of the translation apparatus is 48 from “active” to “inactive”. The network communication apparatus 50 receives the control event 150c through a change of state of the DTR control lead of its DB9 connector from “active” to “inactive”. Effectively, the translation apparatus 48 has transmitted the call termination request to the network communication apparatus 50. At this stage the network communication apparatus 50 sends a message stream 160 to the remote device 28 to terminate the two-way communication session between modems. The process of call termination is inherent to the network communication apparatus 50 and the remote device 28 and will be apparent to those skilled in the art.

Upon successful termination of the two-way session between the network communication apparatus 50 and the remote device 28, the network communication apparatus 50 generates a control event 165a comprising a call termination confirmation signal. In one specific non-limiting example, the control event 165a is a change of state of the DCD control lead of the DB9 connector of the network communication apparatus 50 from “active” to “inactive”. The translation apparatus 48 receives the control event 165a through a change of state of the CTS control lead of its DB9 connector from “active” to “inactive”. Effectively, the network communication apparatus 50 has transmitted the call termination confirmation signal to the translation apparatus 48.

The translation apparatus 48 then generates a message stream 165b comprising the information representing the changed state of the CTS control lead. As was discussed in greater detail above in respect to the message stream 100b, the translation apparatus 48 packetizes the message stream 165b into packet(s) compatible with the packet-based network 14 and transmits the packet(s) comprising the message stream 165b to the translation apparatus 24 over the packet-based network 14. The translation apparatus 24 receives the packet(s) comprising the message stream 165b and extracts the information representing the changed state of the CTS control lead.

Based on the received information representing the changed state of the CTS control lead, the translation apparatus 24 generates a control event 165c comprising the call termination confirmation signal. In one specific non-limiting example, the control event 165c is a change of state of the RTS control lead of the DB9 connector of the translation apparatus 24 from “active” to “inactive”. The requesting apparatus 22 receives the control event 165c through a change of state of DCD control lead from “active” to “inactive”. Effectively, the translation apparatus 24 has transmitted the call termination confirmation signal to the requesting apparatus 22. At this stage, the two-way session between the requesting apparatus 22 and the remote device 28 has been effectively terminated.

In other embodiments of the present invention, the call termination request can be transmitted as an ATx command (i.e. ATH0 command well known to those skilled in the art). It should be apparent to a person skilled in the art having read the teachings of the present invention, that the ATH0 command would be transmitted from the initiation apparatus 22 to the intermediate apparatus 16 in the same manner as message streams 100a, 100b and 100c. Further, the termination of the two-way communication session could be initiated by the remote device 28 or through a call termination or network failure in the circuit-switched network 18a.

In some embodiments of the present invention, the method 90a then proceeds to step 90-I which can be identical to step 90-I described in greater detail above with reference to FIG. 3A.

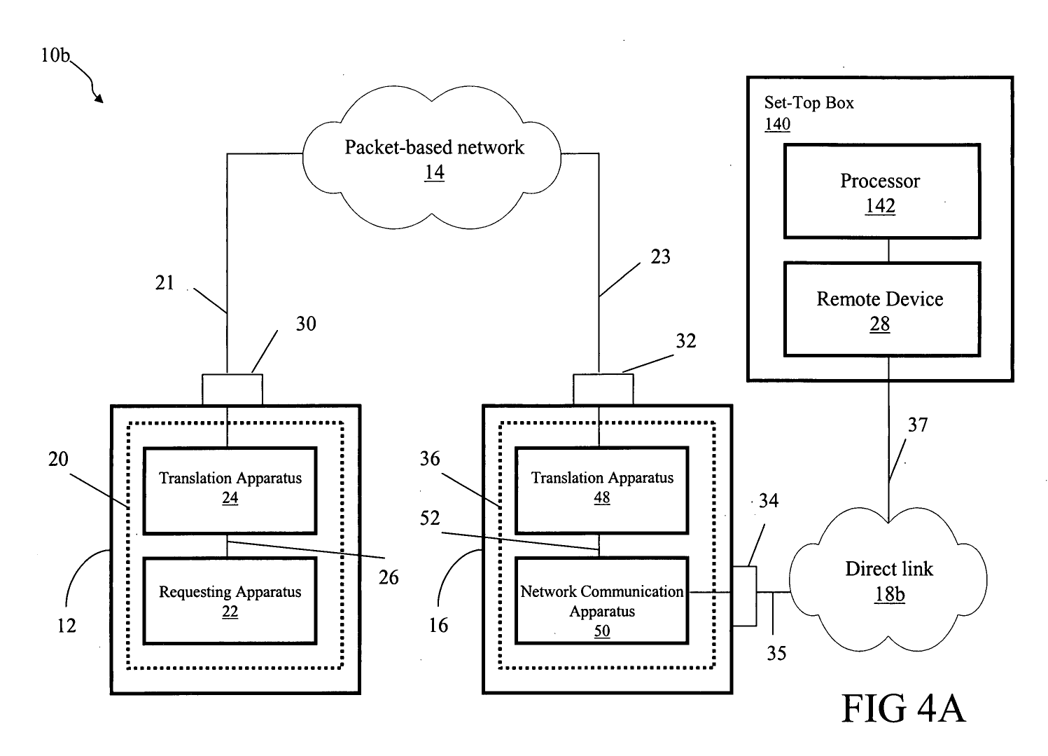

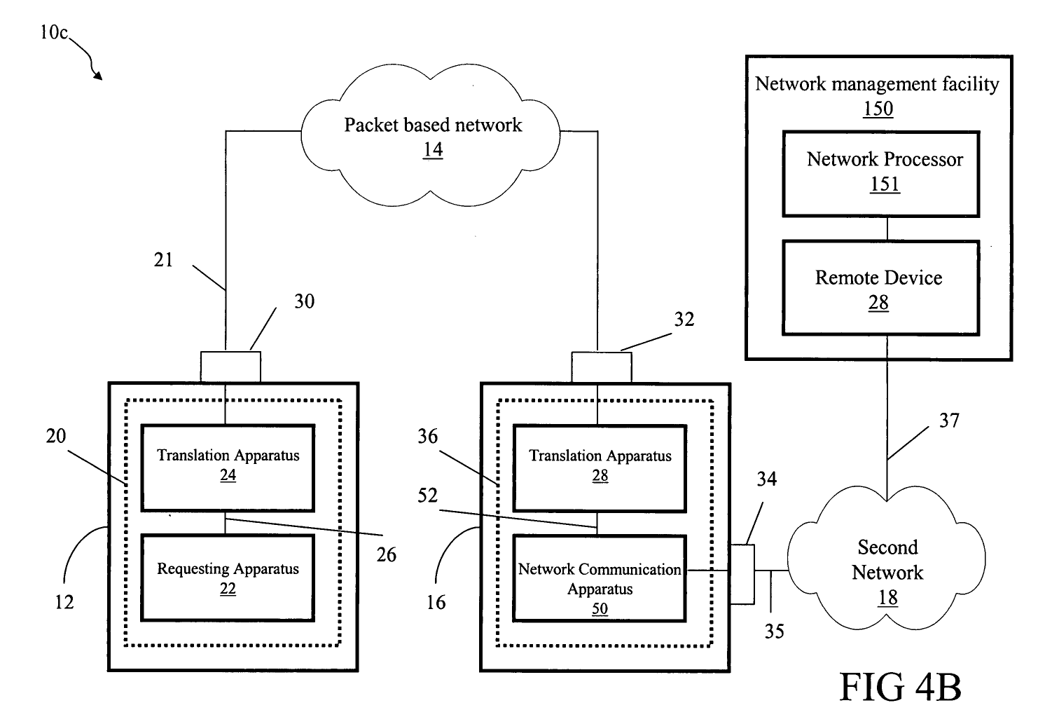

FIG. 4A depicts yet another embodiment of the communication system 10. As shown within communication system 10b, the remote device 28 is incorporated in a set-top box 140. In one specific non-limiting example, the set-top box 140 can be a set-top box adapted to receive satellite broadcast information. For simplicity, the set-top box 140 is depicted to comprise a remote device 28 and a processor 142. It should be apparent, that the set-top box 140 can further comprise a satellite signal receiver, a computing apparatus, security means, and various inputting and outputting interfaces. In one embodiment of the present invention, the remote device 28 is an analog modem. Initiation apparatus 12 comprises the management/control facility of the service provider (i.e. the satellite broadcaster). The second network 18 can be a direct link 18b (such as a standard telephone line, a direct cable link, a WiFi link or the like). In this embodiment, the intermediate apparatus 16 will be installed within or proximate to the premises of the end-user of the set-top box 140.

According to this embodiment of the present invention, the communication system 10b is particularly adapted to initiate communications between the initiation apparatus 12 with the set-top box 140 via the intermediate apparatus 16 and the direct link 18b.

Once the two-way communication session between the initiation apparatus 12 and the remote device 28 is established, as described in greater detail above, the initiation apparatus 12 can transmit the communication data to the processor 142 of the set-top box 140. For example, the communication data can comprise authentication keys, access privilege information and the like. The processor 142 on the other hand can also transmit communication data to the initiation apparatus 12. In one example, the communication data can comprise a request for a micro-billing event (for example, payment for a set-top box based game, payment for additional information to be displayed on one of the set-top box interactive channels, or the like).

In some embodiments of the present invention, once established, the two-way communication channel can be kept active semi-permanently until the set-top box is turned off or the connection is otherwise terminated on occasion, thus allowing for an always-on connection between the initiation apparatus 12 and the set-top box 140. Effectively, the method described herein allows for establishing a connection between the service provider and the customer's set-top box having an analog modem without occupying the customer's telephone line by allowing the communications to traverse a packet-based network that can be out of band from analog voice communications (such as DSL or cable Internet).

FIG. 4b depicts yet another embodiment of the present invention. As shown within communication system 10c, the remote device 28 comprises a back-end modem located at a network management facility 150 coupled to the network processor 151.

In this embodiment, the method described herein is particularly adapted to establish communications between the initiation apparatus 12 and the remote device 28 via the second network 18. The second network 18 can comprise a circuit-switched network, a direct link connection or a packet-based network that is distinct from the packet-based network 14 (ex. different protocol, different security controls, different physical infrastructure, etc.). In one embodiment, the second network 18 comprises the PSTN. In another embodiment, the second network 18 can have different security settings from that of the packet-based network 14 (for example, packet-based network 14 can comprise a public Internet and second network 18 can comprise a corporate local area network with significantly higher security settings than that of the Internet).

Effectively, the initiation apparatus 12 (ex. a remote network administrator) can access the network processor 151 via the intermediate apparatus 16 and the second network 18. In case of the second network 18 comprising a circuit-switched network, the system 10c allows a network administrator, who lacks access to the circuit-switched network, to access the network management facility 150. In case of the second network 18 comprising a packet-based network different from that of the packet-based network 14 or the second network 18 comprising a direct link, the system 10c allows the remote network administrator to connect to and access the network management facility 150 that would otherwise be difficult due to different communication protocols or physical barriers used.

Therefore, according to the teachings of the present invention a system, apparatus and method for remote initiation of communications are provided.

Persons skilled in the art will appreciate that there are yet more alternative implementations and modifications possible for implementing the present invention, and that the above implementations and examples are only illustrations of one or more embodiments of the present invention. The scope of the invention, therefore, is only to be limited by the claims appended hereto.

What claimed is:

1. An apparatus for initiating communications with a remote device, the apparatus comprising:
a first interface adapted to be coupled to a packet-based network;
a second interface adapted to be coupled to a second network;
a processing apparatus, coupled to said first and second interfaces, operable to receive a connection initiation request comprising control information via said first interface and to initiate communication with the remote device using said control information through said second interface.

2. The apparatus according to claim 1, wherein said processing apparatus is further operable to receive communication data via said first interface and to transmit said communication data to the remote device via said second interface.

3. The apparatus according to claim 1, wherein said control information comprises a triggering signal.

4. The apparatus according to claim 3, wherein said triggering signal comprises information representing a changed state of at least one control lead.

5. The apparatus according to claim 3, wherein said processing apparatus is further operable to at least one of store an identifier associated with the remote device and access an identifier associated with the remote device.

6. The apparatus according to claim 1, wherein said control information comprises an identifier associated with the remote device.

7. The apparatus according to claim 1, wherein said control information comprises information representing a changed state of at least one control lead and an identifier associated with the remote device.

8. The apparatus according to claim 7, wherein said processing apparatus is operable to receive said changed state of at least one control lead separately from said identifier associated with the remote device.

9. The apparatus according to claim 1, wherein said processing apparatus comprises a translation apparatus and a network communication apparatus.

10. The apparatus according to claim 9, wherein said translation apparatus is coupled to said network communication apparatus via an RS232 link and wherein said translation apparatus comprises a packet to RS232 converter.

11. The apparatus according to claim 9, wherein said translation apparatus is operable to receive said connection initiation request, to extract said control information from said connection initiation request and to relay said control information to said network communication apparatus.

12. The apparatus according to claim 11, wherein said control information comprises at least one of information representing a changed state of at least one control lead and an identifier associated with the remote device.

13. The apparatus according to claim 9, wherein said network communication apparatus comprises a modem.

14. The apparatus according to claim 1, wherein said second network comprises a switched network.

15. The apparatus according to claim 14, wherein said network communication apparatus comprises a modem and said control information comprises a number associated with the remote device to be dialled by said modem in order to initiate communication with the remote device.

16. The apparatus according to claim 15, wherein the remote device comprises a modem within a financial transaction processing facility.

17. The apparatus according to claim 16, wherein said processing apparatus is further operable to receive a request for financial transaction authorization via said first interface and to transmit said request for financial transaction authorization to the remote device via said second interface.

18. The apparatus according to claim 17, wherein said processing apparatus is further operable to receive a response for said financial transaction authorization request from the remote device via said second interface and to transmit said response via said first interface.

19. The apparatus according to claim 15, wherein said remote device comprises a modem coupled to a network management apparatus.

20. The apparatus according to claim 1, wherein said second network comprises a direct connection.

21. The apparatus according to claim 20, wherein said network communication apparatus comprises a modem and said control information comprises a number associated with the remote device to be dialled by said modem in order to initiate communication with the remote device.

22. The apparatus according to claim 21, wherein said remote device comprises a modem coupled to a set-top box.

23. The apparatus according to claim 21, wherein said remote device comprises a modem coupled to a network management apparatus.

24. A method of initiating communication with a remote device, comprising:
receiving a connection initiation request comprising control information via a packet-based network;
extracting said control information from said connection initiation request;
initiating communication with the remote device using said extracted control information via a second network;

25. The method according to claim 24, further comprising:
receiving communication data;
transmitting said communication data to the remote device via said second network.

26. The method according to claim 24, wherein said control information comprises a triggering signal.

27. The method according to claim 26, wherein said triggering signal comprises information regarding a changed state of at least one control lead.

28. The method according to claim 26 further comprising retrieving an identifier associated with the remote device upon said extracting said control information from said connection initiation request and wherein said initiating communication with the remote device is further using said identifier.

29. The method according to claim 24, wherein said control information comprises an identifier associated with the remote device.

30. The method according to claim 24, wherein said control information comprises information representing a changed state of at least one control lead and an identifier associated with the remote device.

31. The method according to claim 24, wherein extracting said control information comprises depacketizing said connection initiation request and converting said control information to RS232.

32. The method according to claim 31, wherein said control information comprises information representing a changed state of at least one control lead and wherein said converting said control information to RS232 is performed while preserving said information regarding the changed state of the at least one control lead.

33. The method according to claim 24, further comprising verifying the readiness to establish communications via said second network and transmitting a readiness confirmation signal via said packet-based network.

34. The method according to claim 33, wherein said verifying the readiness to establish communications via said second network is triggered by receiving a connection verification request.

35. The method according to claim 33, wherein said verifying the readiness to establish communications via said second network and transmitting said readiness confirmation signal is performed periodically.

36. The method according to claim 33, wherein said verifying the readiness to establish communications via said second network and transmitting said readiness confirmation signal is performed at one or more predetermined times.

37. The method according to claim 33, wherein said verifying the readiness to establish communications via said second network and transmitting said readiness confirmation signal is performed after a pre-determined event.

38. The method according to claim 24, wherein said remote device comprises a modem and said second network comprises a switched network; and wherein said initiating communication with the remote device comprises dialling a number associated with the remote device and handshaking with the remote device.

39. The method according to claim 38, wherein said control information comprises said number associated with the remote device.

40. The method according to claim 38 further comprising retrieving said number associated with the remote device from a storage device.

41. The method according to claim 25, wherein the remote device is a modem located at a financial transaction processing facility and said communication data comprises a request for financial transaction authorization.

42. The method according to claim 41 further comprising receiving a response from the remote device based on said request for financial transaction authorization.

43. The method according to claim 42 further comprising disengaging said initiated communication after said response has been received.

44. A system for initiating communication with a remote device comprising:
an initiation apparatus, coupled to a packet-based network, for generating a connection initiation request comprising control information; said initiation apparatus operable to packetize and transmit said connection initiation request over said packet-based network; and
an intermediate apparatus, coupled to said packet-based network and to a second network, for receiving said packetized connection initiation request from said packet-based network; said intermediate apparatus further operable to depacketize said packetized connection initiation request to extract said control information and to initiate communication with the remote device via the second network based on said control information.

45. The system according to claim 44, wherein said initiation apparatus is further operable to generate communication data and to transmit said communication data to the intermediate apparatus via said packet-based network; and said intermediate apparatus is further operable to receive said communication data from said packet-based network and to transmit said communication data to the remote device via said second network.

46. The system according to claim 45, wherein the remote device is operable to generate a response based on said communication data and transmit said response to said initiation apparatus via said second network, said intermediate apparatus and said packet-based network.

47. The system according to claim 44, wherein said initiation apparatus comprises a requesting apparatus and a first translation apparatus coupled to said packet-based network; said intermediate apparatus comprises a second translation apparatus coupled to said packet-based network and a modem; and said remote device comprises a remote modem.

48. The system according to claim 47, wherein said requesting apparatus is operable to generate said connection initiation request and to transmit said connection initiation request to said first translation apparatus;
wherein said first translation apparatus is operable to packetize and transmit said connection initiation request via said packet-based network to said second translation apparatus;
wherein said second translation apparatus is operable to depacketize and transmit said connection initiation request to said modem; and
wherein said modem is operable to receive said connection initiation request and to initiate communications with said remote modem based on said control information upon receipt of said connection initiation request.

49. The system according to claim 48, wherein said requesting apparatus comprises a financial transaction apparatus operable to generate a financial transaction authorization request and said generation of said connection initiation request is in response to said generation of said financial authorization request.

50. The system according to claim 49, wherein said financial transaction apparatus is operable to transmit said financial authorization request to said remote modem via said first translation apparatus, said packet-based network, said second translation apparatus, said modem and said second network, upon initiation of communication between the modem and the remote modem.

51. An apparatus for initiating communication with a remote device, the apparatus comprising:
means for receiving a connection initiation request comprising control information from a packet-based network;
means for extracting said control information from said connection initiation request; and
means for initiating communication with the remote device using said control information via a second network.

52. The apparatus according to claim 51 further comprising
means for receiving communication data,
means for transmitting said communication data to the remote device via said second network.

53. A computer-readable media storing a plurality of programming instructions for execution on a computing apparatus that is connectable to a packet-based network and to a second network, said instructions for rendering said computing apparatus to receive a connection initiation request comprising control information via said packet-based network; to extract said control information from said connection initiation request; and to initiate communication with a remote device using said control information through said second network; said instructions for further rendering said computing apparatus to receive communication data and to transmit said communication data to the remote device via the second network.
